(19) United States
(12) Patent Application Publication
(10) Pub. No.: US 2025/0184173 A1
(43) Pub. Date: Jun. 5, 2025

(54) SYSTEM AND METHOD FOR APPLIANCE DETECTION, APP CONFIGURATION, AND SMART LOCK CONTROL

(71) Applicant: Universal Electronics Inc., Scottsdale, AZ (US)

(72) Inventors: Paul D. Arling, Scottsdale, AZ (US); Arsham Hatambeiki, San Francisco, CA (US)

(21) Appl. No.: 18/525,241

(22) Filed: Nov. 30, 2023

(51) Int. Cl. H04L 12/28; F24F 11/56; F24F 11/64

(52) U.S. Cl. CPC H04L 12/2816; F24F 11/56; F24F 11/64; H04L 12/2809; H04L 2012/2841

(57) ABSTRACT

A non-transitory, computer readable media has instructions stored thereon which instructions, when executed by a processing device of a first smart device, cause the first smart device to receive from a smart lock device on a wireless network which includes the first smart device a communication having data indicative of a state of the smart lock device and to respond to receiving the data by causing a command that has been linked to the state of the smart lock device to be executed.

### BACKGROUND

Personal communication, productivity, and entertainment devices such as cellular phones, tablet computers, e-books, hand-held games, portable media players, PDAs, etc. are known to include features such as graphical user interfaces on color touch screens, Bluetooth and/or WiFi capability, etc. Many such devices also incorporate support for ancillary applications (hereafter referred to as “apps”) for example calendars, email, games, social media interfaces, maps, and navigation, etc. Furthermore, support for such apps may be provided as a feature of certain entertainment appliances such as for example so-called “smart TVs,” cable or satellite set top boxes, etc. For the sake of brevity, all such app capable devices whether personal/portable or appliance-based, will be collectively referred to hereafter as “smart devices.”

Contemporaneously, an increasing number of household appliances such as, for example, thermostats, clothes washer/driers, dishwashers, refrigerators, solar power array controllers, etc., are becoming network enabled, i.e., these appliances are capable of communicating status and/or receiving commands over a local and/or wide area network. To fully utilize these features, a user of such an appliance may locate and download into a smart device an appliance manufacturer supplied app which serves to provide an appropriate appliance interface. In some instances, the process of locating and installing an appliance specific app can be automated as described in U.S. Pat. No. 10,063,625.

By way of further example, U.S. Pat. No. 9,892,579 describes an appliance in the form of a smart lock that is operable via use of an app provisioned to a smart device and a control method of the smart lock that is implemented by the smart device which is communicably coupled to the smart lock. The control method includes the steps of sensing touch inputs performed upon the smart device so as to generate a sensing signal, determining whether the sensing signal conforms to a preset touch code, which is associated with a predetermined sequence of touch inputs on the mobile device, generating a control signal which is to be transmitted to the smart lock for controlling the smart lock to lock or unlock when it is determined that the sensing signal conforms to the preset touch code, and transmitting the control signal to the smart lock.

As concerns the apps installed on the smart device, AU 2020204573 describes methods, devices, and systems for inter-app communications between software applications on a mobile communications device. In one aspect, a computer-readable medium on a mobile computing device comprising an inter-application communication data structure to facilitate transitioning and distributing data between software applications in a shared app group for an operating system of the mobile computing device includes a scheme field providing a scheme id associated with a target software app to transition to from a source software app, wherein the scheme id is listed on a scheme list stored with the source software app; and a payload field of the data structure providing data and/or an identification where to access data in a shared file system accessible to the software applications in the shared app group, wherein the payload field is encrypted.

### SUMMARY

The following relates generally to a smart lock device that utilizes an app installed on the smart device that is made aware of a status of the smart lock device. The app receives notifications from the smart lock (e.g. open or closed) and, in some examples, may be used to control the smart lock (e.g., lock or unlock). In some examples, the app may use notifications received from the smart lock and/or commands sent to the smart lock to formulate commands to be sent to directly control other appliances within the home. In some examples, the app may use notifications received from the smart lock and/or commands sent to the smart lock to formulate commands to be sent to directly control other apps installed on the smart device. In some examples, the app may simply forward data concerning the smart lock to other appliances and/or other apps. In some examples, an app may be programmed so that the decisions made by the app are personalized to the user of the smart device upon which the app is installed. In some examples, communications between the smart device, the smart lock, and possibly any additional appliances, may be performed using Ultra Wide band and, in such instances, an app may be programmed so that the decisions made by the app are also location dependent. In some examples, the app installed on a smart device shares information with other, like apps installed on other smart devices that may be within the area of the smart lock and command and control decisions made by the multiple apps can be determined based on established user priorities, location priorities, or the like.

A better understanding of the objects, advantages, features, properties and relationships of the subject systems and methods will be obtained from the following detailed description and accompanying drawings which set forth illustrative embodiments and which are indicative of the various ways in which the principles of the invention may be employed.

### BRIEF DESCRIPTION OF THE DRAWINGS

For a better understanding of the various aspects of the described systems and

methods, reference may be had to preferred embodiments shown in the attached drawings in which:

FIG. 1 illustrates an exemplary system in which an app-equipped smart device may be utilized to interface several different appliances including a smart lock, a security system, and a thermostat/HVAC equipment; and

FIG. 2 illustrates in block diagram form an exemplary smart device which may be used in the exemplary systems of FIG. 1.

### DETAILED DESCRIPTION

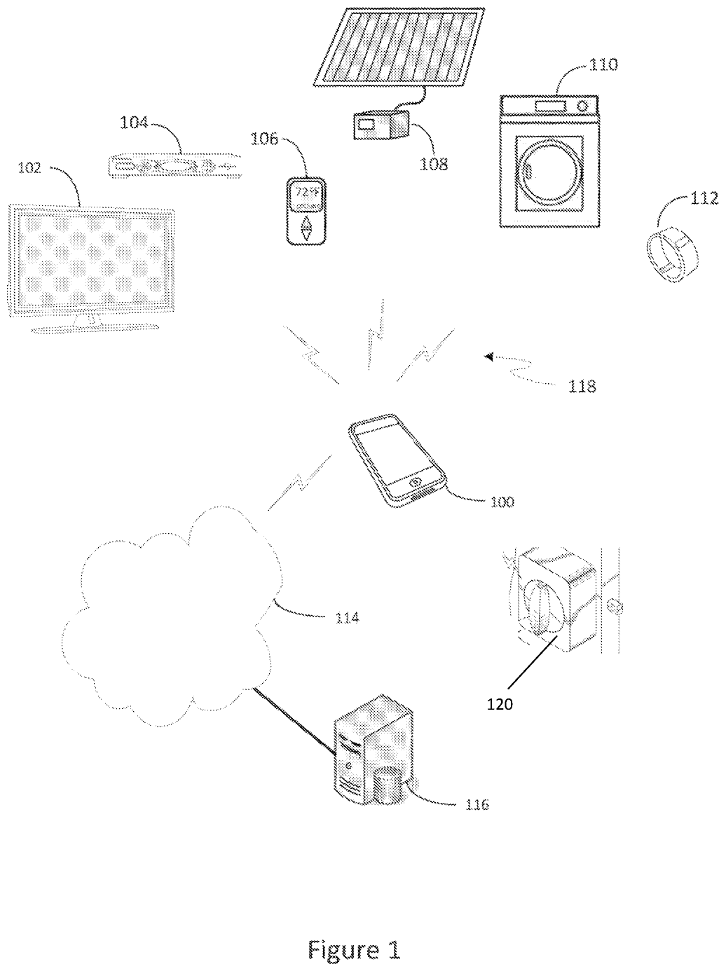

With reference to FIG. 1, there is illustrated an exemplary system in which apps installed on a smart device 100 may provide interfaces to various controllable appliances, such as, for example, a television 102, a cable or satellite set top box 104, a thermostat 106 coupled to a heating and/or cooling system, a solar power array controller 108, a clothes washer and/or drier 110, a personal fitness tracker or pedometer 112, a smart lock 120, etc. The interfaces may be used to display information relevant to the operation and/or states of such devices, to communicate with and/or control such devices, etc. To this end, all of these appliances may communicate with smart device 100 using an available local wired or wireless network 118 such as, for example, WiFi, Bluetooth, etc. In a preferred embodiment, communications between at least smart lock 120 and the smart device 100 will utilize ultra-wideband (UWB) which is a short-range, wireless communication protocol that operates through radio waves. UWB operates at very high frequencies and has the advantage of being able to be used to capture highly accurate spatial and directional data. In addition, UWB may be used to turn a UWB-enabled smart device 100 into a digital key to lock and unlock the smart lock 120 as desired. While illustrated as having a single smart device 100 and a single smart lock 120, it will be understood that the system may have multiple smart devices 100 each of which may be utilized to display information relevant to the operation and/or states of the various devices, to communicate with and/or control the various devices, etc., including multiple smart locks 120. It will also be appreciated that, depending on the particular networking technology in use, various other items such as access points, routers, Internet gateways, etc., may be required to fully implement certain features and functions of the illustrative network 118 and that, in the interest of clarity, these are omitted from FIG. 1. Nevertheless, while the smart device 100 may be adapted to communicate with one or more remote servers 116 by way of a wide area network 114, such as for example the Internet, in a preferred embodiment the interactions described hereinafter as concerns the use of lock status data do not need to go to the cloud for automated control to be executed, particularly when UWB is used as the communication protocol.

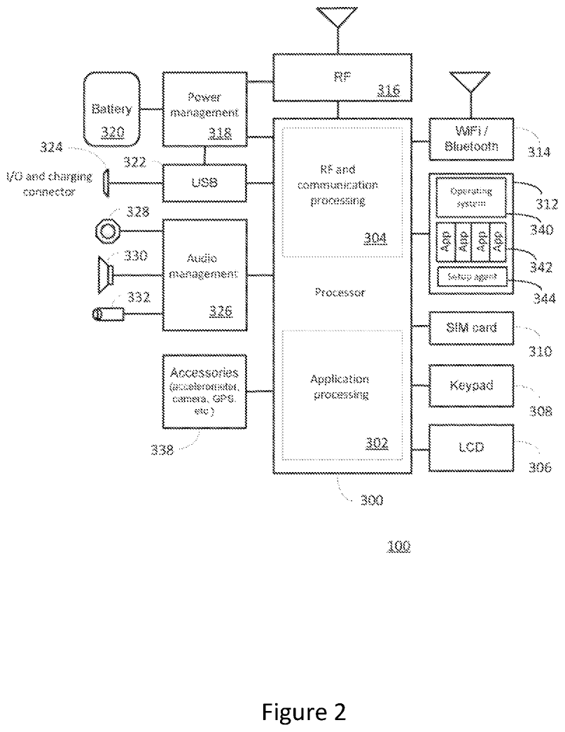

With reference to FIG. 2, the smart device 100 of FIG. 1 may include, as needed for a particular application, processing means 300 which may comprise both an application processing section 302 and an RF/communication processing section 304; an LCD display 306; a keypad 308 which may comprise physical keys, touch keys overlaying LCD display 306, or a combination thereof; a subscriber identification module (SIM) card 310; memory means 312 which may comprise ROM, RAM, Flash, or any combination thereof; WiFi and/or Bluetooth wireless interface(s) 314; a wireless telephony interface 316; power management circuitry 318 with associated battery 320; a USB interface 322 and connector 324; an audio management system 326 with associated microphone 328, speaker 330 and headphone jack 332; and various optional accessory features 338 such as a digital camera, GPS, accelerometer, etc. Programming may be provided and stored in memory means 312 to control the operation of smart device 100 by way of operating system 340 software such as for example iOS, Android, Linux, Web apps, etc., which operating software may support the download and execution of various add-on apps 342 as necessary for a particular purpose, all as well known in the art. In addition, a setup agent software 344 may also be provisioned to smart device 100 in order to facilitate detection, installation, and operation of manufacturer-supplied appliance interface apps. It is also to be understood that, while the illustrated smart device 100 is particularly adapted to receive input via use of a keypad and/or touchpad display that is provided as an integral part of the smart device 100, the smart device 100, or other like smart devices such as a TV, can be provided input via use of further remote devices such as a remotely located mouse, pointer device, touch pad, or the like. These remotely located input devices would accordingly be adapted to communicate data to an associated smart device that is indicative of user interactions with such input devices to thereby achieve the same purposes described herein, e.g., to navigate and interact with a user interface.

As known in the art, the setup agent 344 may periodically initiate a scan of its current wired or wireless, network environment (e.g., WiFi, Bluetooth, UWB, etc. or any combination thereof) in order to ascertain the presence of one or more networked appliances. This action may be initiated automatically (for example based on a timer which is used to measure predetermined periods of time, in response to the device being turned on, in response to a detected change in location of the smart device 100 using for example its GPS, UWB or the like type of functionality, etc.), or when connecting to new networks, or may be manually initiated by a user of smart device 100 (for example in response to an activation of a user input element, in response to the smart device 100 being moved, etc.) as appropriate for a particular embodiment. If it is determined that no responsive appliances are present in the environment, the setup agent actions are complete. If, however, responsive devices are detected on the wireless network, e.g., a device responds with data indicative of its identity in response to a polling request message sent from the smart device 100, then the setup agent may next determine, using the information received, if a responsive appliance is already known to the setup agent, e.g., determine if the appliance has already been detected during a previous detection operation or otherwise manually indicated to the smart device 100. Such a determination may be made, for example, by consulting a setup agent-administered listing of appliance identities. If the appliance is already known to the setup agent, processing continues to determine if further responsive appliances have been detected.

If it is determined that a newly-responsive appliance has been detected, the setup agent may next determine if an app is available for that appliance. Such a determination may be made, for example, by using vendor information, a third party compatibility database, or by a social network database which may contain related appliance information updated by other users or by searching a database that functions to cross-reference appliance identifying data as would be received from the appliances (e.g., data indicative of a manufacturer and model number) to available apps and locations from which such apps may be download. Such a database may be stored in local memory 312 as part of the setup agent programming, may be located at a cloud based data storage facility or server 116, or a combination thereof, as appropriate for a particular embodiment. If no app is available, processing continues, adding the instant appliance identity to the listing of known appliance identities. If it determined that an app is available, the appropriate app may be recommended to the user or may be downloaded to the smart device 100 from a location indicated in the database entry, e.g., a location pointed to by use of a URL, IP address, etc. As will be appreciated, depending on the particular implementation such a download and install may be performed automatically by the setup agent, or the agent may first present the download possibility to the user of smart device 100 for confirmation. As will also be appreciated, in those instances where the app download is sourced from a site which requires user sign-in and/or authentication, such as for example the “iTunes” brand store or “Android Marketplace” brand store, user credentials may be pre-loaded into the setup agent program to facilitate such automatic download or may be requested from smart device user each time download is to be performed.

When an app is downloaded and installed, the setup agent may automatically register that app with the app that is associated with the smart lock 120 or with an intermediate app provisioned to the smart phone that can be utilized to place the app that is associated with the smart lock 120 into communication with that app. Such registration information may be subsequently utilized for the purpose of allowing apps installed on the same smart device 100 and/or installed on other smart devices 100 within the system to communicate data and/or commands as will be further described hereafter. In this regard, the registration information may include the information needed to access APIs that are provided to facilitate the communication of such data and commands, to configure remote control functionality, etc. It will also be appreciated that, once the discovery process is completed a user may be presented with a listing of appliances and/or apps in a user interface that is provided to allow for a manual registering of appliances and/or apps with the smart lock 120 app (or an intermediate app in communication with the smart lock 120 app as appropriate).

Once the apps and/or appliances are linked to the smart lock 120 app, a user may be presented with a further listing of features and/or functionalities that can be controlled using data and/or commands originating from the smart lock 120 app. For example, a user can be provided with listing of commandable settings associated with the thermostat 106 and states associated with the smart lock 120. The user may then use the user interface to link one or more of the commandable settings of the thermostat, such as a desired temperature, with a detectable state for the smart lock 120, such as a detected transition from a locked state to an unlocked state. In this regard, once a feature, function, or setting has been linked by a user to a detectable state of the smart lock 120, the smart lock 120 app (or the intermediate app) will function to generate a command, a data transmission, and/or a macro command sequence as necessary to cause the linked to appliances to be placed into the required state(s) (e.g., heat turned on to 70 degrees, hallway lights turned on, television turned on, outside light turned off, etc.) upon initiation of the app in response to the detectable state being reported to the smart lock 120 app by the smart lock 120. (e.g., the smart lock reporting a transition from unlocked to locked). In a similar manner, a user interface may also provide a means for user to instruct that an appliance app or an appliance provide state information to the smart lock 120 app in response to a detected state change whereupon the smart lock 120 app can respond to receiving such appliance/app state information to control the state of the smart lock 120, i.e., to lock or unlock the smart lock 120 in response to a detected condition within the home environment. Since methods for control of appliances and/or use of macros are well known in the art, these will not be discussed further herein, however for additional information the interested reader may turn to for example U.S. patent application Ser. No. 13/657,176 “System and Method for Optimized Appliance Control” or Ser. No. 13/071,661 “System and Method for Facilitating Appliance Control via a Smart Device.”

For ease of use, provision may also be made within the app programming to allow a user to purge or edit entries in the tabulation of known appliances, for example when a smart device is permanently relocated to a different environment, etc. Removal of known appliance tabulation entries may also be performed automatically by the app when a previously responsive appliance has failed to acknowledge several scan cycles; when an associated app is deleted by the user of the smart device; etc.

Still further, in instances where UWB is utilized, the smart lock 120 app could be instructed to perform command and/or data transfer actions in response to a detected condition of the smart device 100 relative to the smart lock 120, as reported to the smart lock 120 app by the smart device 100. For example, in response to the smart device 100 detecting via use of UWB communications from the smart lock 120 that the smart device 100 is moving away from the smart lock 120, the smart lock 120 app can be caused to send a command to the smart lock 120 to ensure that the smart lock 120 is in the locked state. In addition, multiple different command actions can be associated with a given state of a smart lock 120 and these command actions can be selected to be performed based upon a position of the smart device 100 relative to the smart lock 120 as determined via use of UWB communications. For example, a first action will be performed if the state of the smart lock 120 changes while a smart device is within a certain area relative to the smart lock 120 and a second action will be performed if the state of the smart lock 120 changes while the smart device is outside of the certain area relative to the smart lock 120. It is to be appreciated that, within the context of this disclosure, an action may also be considered to be the non-sending of a command or the non-sending of a state data which might otherwise be performed.

Yet further, when multiple smart lock 120 apps are installed on multiple smart devices 100, the smart lock 120 apps can communicate with each other to determine which, if any, actions to be performed when each is informed of a state of a smart lock 120. In this regard, the smart lock 120 apps can be given priorities such that, if a given smart lock 120 app is informed of a state change, the actions associated with that state change within that app will be given priority over actions associated with that state change within other apps installed on other smart devices 100 within that environment. Likewise, the actions to be performed by an app installed on one smart device can be given a priority over the actions to be performed by an app installed on another smart device based upon the determined locations of the smart devices within the environment. In other words, actions that would otherwise be performed by the app, such as turning off a light in response to a smart door lock 120 transitioning from unlocked to locked with a smart device 100 being determined to be outside of the home, may be overridden when it is determined that another smart device 100 remains in the home.

In summary, by using the personal device (e.g., a phone) to distribute messages and distribute notifications from different smart home devices/brands/services to one another, the described systems and method have the advantage of eliminating the need for a user to go through a lengthy and one by one processes of connecting different smart home devices/services together, particularly where the devices/services are of different brands using different communication protocols. Rather, when, for example, the smart lock is from brand X and the home security equipment is brand Y and both of their informational and control apps are installed on the personal device, the personal device will function to tie smart home category messages/notifications between these app without requiring the user to perform setup/configuration processes directly with the respective devices or their respective apps. More particularly, the advantage is achieved by simply allowing the security provider to subscribe to a smart lock category of notification in the phone, and in this manner, if/when a user installs an app on their personal device that supports, i.e., provides, smart lock notifications of the subscribed to category, the system will function to automatically redirected to the subscriber(s) any notification that is of that type of notification. While, in some instances, a user may be required to manually provide permission for the notifications to be exchanged, this step is minimal as compared to the steps required of the prior art. Furthermore, the systems and methods described herein have the advantage of not requiring a user to link user IDs among these apps as the notifications are merely being exchanged within the same personal device.

While various concepts have been described in detail, it will be appreciated by those skilled in the art that various modifications and alternatives to those concepts could be developed in light of the overall teachings of the disclosure. For example, while the illustrative embodiment above is presented in terms of a setup agent resident in a portable smart device such as a phone or tablet, it will be appreciated that the teachings herein may be equally applicable to other app-capable device such as for example without limitation “smart” TVs, cable or satellite set top boxes, streaming video devices, home automation systems, and the like. Further, while described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

All patents cited within this document are hereby incorporated by reference in their entirety.

What is claimed is:

1. A non-transitory, computer readable media having instructions stored thereon which instructions, when executed by a processing device of a first smart device, cause the first smart device to perform steps comprising:
receiving from a smart lock device on a local area, wireless network which includes the first smart device a communication having data indicative of a state of the smart lock device; and
in response to receiving the data, causing a command that has been linked to the state of the smart lock device to be executed.

2. The non-transitory, computer-readable media as recited in claim 1, wherein the command comprises a command to control a state of a heating and/or cooling appliance.

3. The non-transitory, computer-readable media as recited in claim 1, wherein the instructions, when executed by the processing device, cause the first smart device to discover a controllable device within the wireless network and to automatically link to an app for controlling the controllable device whereby, in response to receiving the data, the instructions cause the command that has been linked to the state of the smart lock device to be executed by being sent to the app for controlling the controllable device.

4. The non-transitory, computer-readable media as recited in claim 3, wherein the command comprises a command to control a state of a heating and/or cooling appliance.

5. The non-transitory, computer-readable media as recited in claim 1, wherein the wireless network utilizes an ultra-wide band (UWB) communication protocol, the instructions, when executed by the processing device, cause the first smart device to use the UWB communication protocol to determine a location of the first smart device relative to the smart lock device, and to additionally use the determined location of the first smart device relative to the smart lock device to determine the command that has been linked to the state of the smart lock device.

6. The non-transitory, computer-readable media as recited in claim 5, wherein the command comprises a command to control a state of a heating and/or cooling appliance.

7. The non-transitory, computer-readable media as recited in claim 5, wherein the instructions, when executed by the processing device, cause the first smart device to further use a determined location of a second smart device relative to the smart lock device to determine the command that has been linked to the state of the smart lock device.

8. The non-transitory, computer-readable media as recited in claim 1, wherein causing the command that has been linked to the state of the smart lock device to be executed comprises directly causing a transmitter of the smart device to issue a command to an appliance via the wireless network.

9. The non-transitory, computer-readable media as recited in claim 1, wherein causing a command that has been linked to the state of the smart lock device to be executed comprising causing the instructions to issue a command to an appliance related app installed on the first smart device.

10. The non-transitory, computer-readable media as recited in claim 1, wherein causing a command that has been linked to the state of the smart lock device to be executed comprising causing the instructions to transmit data indicative of the state of the smart lock device to an appliance related app installed on the first smart device.

11. A smart device, comprising:
a processing device;
a wireless communications device coupled to the processing device; and
a memory coupled to the processing device, wherein the memory stores instructions which instructions, when executed by the processing device, cause the smart device to perform steps comprising:
receiving from a smart lock device on a local area, wireless network to which the wireless communications device is coupled a communication having data indicative of a state of the smart lock device; and
in response to receiving the data, causing a command that has been linked to the state of the smart lock device to be executed.

12. The smart device as recited in claim 11, wherein the command comprises a command to control a state of a heating and/or cooling appliance.

13. The smart device as recited in claim 11, wherein the instructions, when executed by the processing device, cause the smart device to discover a controllable device within the wireless network and to automatically link to an app for controlling the controllable device whereby, in response to receiving the data, the instructions cause the command that has been linked to the state of the smart lock device to be executed by being sent to the app for controlling the controllable device.

14. The smart device as recited in claim 13, wherein the command comprises a command to control a state of a heating and/or cooling appliance.

15. The smart device as recited in claim 11, wherein the wireless network utilizes an ultra-wide band (UWB) communication protocol, the instructions, when executed by the processing device, cause the smart device to use the UWB communication protocol to determine a location of the smart device relative to the smart lock device, and to additionally use the determined location of the smart device relative to the smart lock device to determine the command that has been linked to the state of the smart lock device.

16. The smart device as recited in claim 15, wherein the command comprises a command to control a state of a heating and/or cooling appliance.

17. The smart device as recited in claim 15, wherein the instructions, when executed by the processing device, cause the smart device to further use a determined location of a further smart device relative to the smart lock device to determine the command that has been linked to the state of the smart lock device.

18. The smart device as recited in claim 11, wherein causing the command that has been linked to the state of the smart lock device to be executed comprises directly causing the wireless communications device of the smart device to issue a command to an appliance via the wireless network.

19. The smart device as recited in claim 11, wherein causing a command that has been linked to the state of the smart lock device to be executed comprising causing the instructions to issue a command to an appliance related app installed on the smart device.

20. The smart device as recited in claim 11, wherein causing a command that has been linked to the state of the smart lock device to be executed comprising causing the instructions to transmit data indicative of the state of the smart lock device to an appliance related app installed on the smart device.
